(19) United States
(12) Patent Application Publication
(10) Pub. No.: US 2014/0081687 A1
(43) Pub. Date: Mar. 20, 2014

(54) MULTIPLE SIMULTANEOUS CONTACT CENTER OBJECTIVES

(71) Applicant: AVAYA INC., Basking Ridge, NJ (US)

(72) Inventors: Andrew D. Flockhart, Thornton, CO (US); Robert C. Steiner, Broomfield, CO (US); Joylee Kohler, Colorado Springs, CO (US)

(73) Assignee: AVAYA INC., Basking Ridge, NJ (US)

(21) Appl. No.: 13/623,310

(22) Filed: Sep. 20, 2012

(51) Int. Cl. G06Q 10/06

(52) U.S. Cl. 705/7.13

(57) ABSTRACT

Methods, devices, and systems are provided such that multiple contact center objectives can be simultaneously analyzed and normalized by a single algorithm. A solution is provided for executing an algorithm that is able to consider multiple objectives simultaneously rather than serially. By considering multiple objectives in parallel when making work assignment decisions instead of considering single objectives, decisions and contact center adjustments are made with more efficiency and with a minimal use of resources.

### FIELD

The present disclosure is directed generally to contact centers and specifically to creating and attempting to satisfy multiple contact center objectives simultaneously.

### BACKGROUND

A contact center's success is defined by whether or not the contact center meets or fails to meet multiple objectives. It is the ultimate responsibility of the contact center manager to ensure that the contact center meets its various business objectives. Metrics are the measurements used to track these how well these objectives are being met within the contact center. Metrics traditionally include Wait Time (WT), Predicted Wait Time (PWT), Expected Wait Time (EWT), Average Speed of Answer (ASA), Percent Service Level (% SL), Percent Abandon (% Abandon), etc. The metrics may also be calculated on many different time scales, including Real Time, Interval, Daily, Weekly, Monthly, etc.

When an agent with multiple skills becomes available and the work assignment engine wishes to assign the next item of work, a question arises as to how the group of metrics measuring the contact center objectives can be incorporated into a single assignment decision.

### SUMMARY

Embodiments of the present disclosure, therefore, provide the ability for users to administer business rules for determining work assignment decisions when one or more objectives are administered or when one or more objectives are not being met. Moreover, the objectives may be recalculated every time a decision is made and/or matching may be made simultaneously. The business rules may employ a number of metrics to determine one or more optimal work assignments.

Specifically, the multiple objectives used by the work assignment engine in making a decision may include, but is not limited to, using metrics such as wait times associated with a contact (estimated, actual, average, etc.), skill of one or more contact center agents, efficiency of one or more contact center agents, contact center state, and the like. It is an aspect of the present invention that the work assignment may be influenced by observing a rate of change of one or more metrics. The following metrics may be employed in the optimal decision for a work assignment:

Target Ratios:

One solution in the prior art is to calculate a target ratio for each skill. “Actual/Target.” or “Wait Time/Wait Time Objective.”

An example is the Service Objective feature which is part of Business Advocate. This prior art is limited to real-time wait times. With these target ratios the agent selects the skill with the highest target ratio.

Normalized Target Ratios:

For some metrics, a lower target ratio is desirable (WT, PWT, EWT, ASA, % Abandon). In others a higher target ratio is desirable (% SL). In order to compare the status of objectives of different types, the target ratios need to be normalized. For the first metrics absolute value of “actual-target” is calculated, while for the second metrics absolute value of “target-actual” is calculated. In this way, a target ratio for a skill with an ASA objective can be compared with a skill with a % SL objective and a best work assignment made.

Time-Adjusted Target Ratios:

Contact Center objectives may include metrics with very different time windows; for example: Daily % SL and Monthly % SL. If one skill is failing to meet a daily % SL objective and a second skill is failing to meet a monthly % SL objective, it may be more effective for the agent to focus on the skill with the more important objective even if its target ratio is more problematic that the other. Objectives may also include metrics with very specific time windows: for example: Goal=90% in 30 seconds.

For this reason, target ratios can be adjusted to account for the time remaining “target ratio/logN time-remaining,” where N is 2-10.

Prioritized Target Ratios

Users may wish to administer a priority level for each objective. These priority levels may be hard requirements (there is like prior art for this option) or may be used as preferences when target ratios are essentially equivalent.

Multiple Target Ratios:

Each skill may have multiple different objectives. One skill may have more objectives in trouble than another. The number of failing objectives may also be used as a factor in assignment decisions.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting pools and bitmaps that are utilized in accordance with embodiments of the present disclosure;

FIG. 3 is a block diagram depicting data structures for objectives in accordance with embodiments of the present disclosure;

FIG. 4 is a flow diagram depicting a method to determine work assignments in accordance with embodiments of the present disclosure; and

FIG. 5 is a flow diagram depicting a method of relational integration in accordance with embodiments of the present disclosure.

### DETAILED DESCRIPTION

The ensuing description provides embodiments only, and is not intended to limit the scope, applicability, or configuration of the disclosure. Rather, the ensuing description will provide those skilled in the art with an enabling description for implementing the embodiments. Various changes may be made in the function and arrangement of elements without departing from the spirit and scope of the disclosure as set forth in the appended claims.

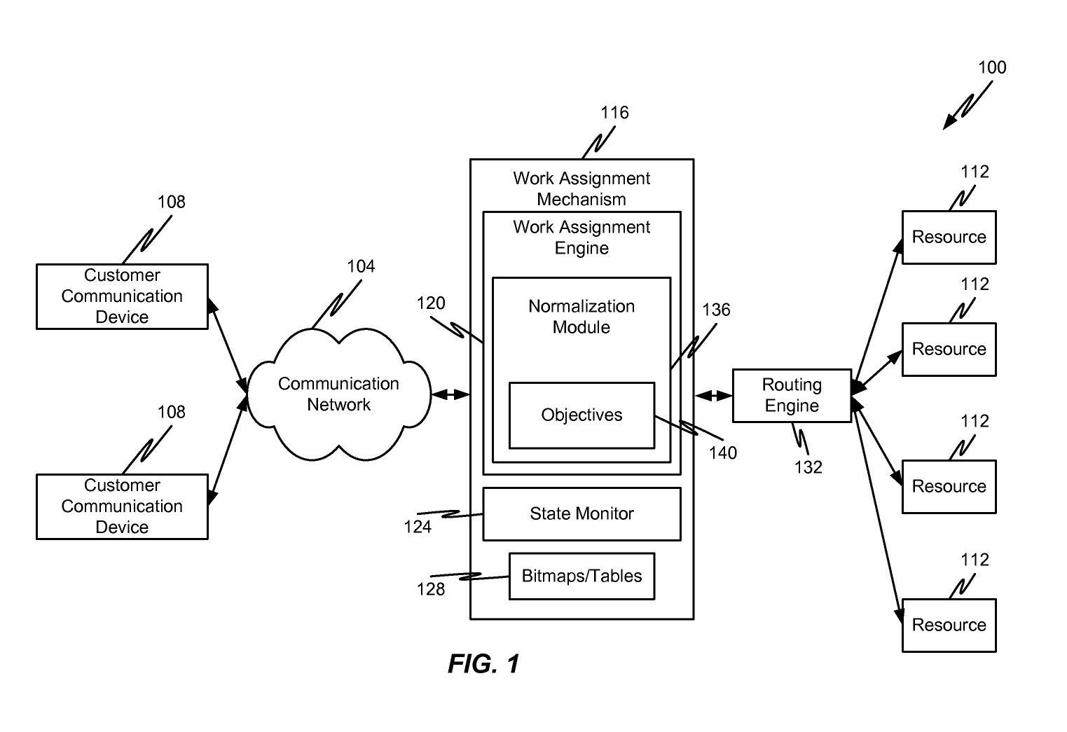

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types.

As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

The format of the work item may depend upon the capabilities of the communication device 108 and the format of the communication. In some embodiments, work items are logical representations within a contact center of work to be performed in connection with servicing the communication received at the contact center (and more specifically a work assignment mechanism 116). The phrase “contact center” as used herein refers to a facility used by companies to manage client contacts made through a variety of mediums such as telephone, fax, letter, e-mail, and online chat. The majority of large organizations use contact centers as a means of managing their client interactions.

The communication associated with a work item may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112. A connection between the customer communication device 108 and a resource 112 may be effected by the routing engine 132 assigning one or more communication resources (e.g., sockets, buffers, physical ports, etc.) to establish a communication path (e.g., media stream such as RTP or SRTP) between the communication device 108 and resource 112. In some embodiments, the communication path established between the communication device 108 and resource 112 may also carry call control signaling, however, it may also be possible to maintain the signaling path at the work assignment mechanism 116.

Although the routing engine 132 is depicted as being separate from the work assignment mechanism 116, the routing engine 132 may be incorporated into the work assignment mechanism 116 or its functionality executed by a work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item may be sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 may be configured to administer and make work assignment decisions in a queueless contact center, as is described in U.S. patent application Ser. No. 12/882,950, the entire contents of which are hereby incorporated herein by reference.

More specifically, the work assignment engine 120 can generate bitmaps/tables 128 and determine, based on an analysis of the bitmaps/tables 128, which of the plurality of processing resources 112 is eligible and/or qualified to receive a work item and further determine which of the plurality of processing resources 112 is best suited to handle the processing needs of the work item. As will be discussed in further detail herein, the work assignment engine 120 may be configured to try and satisfy one or more objectives 140 when making work item routing decisions. In some embodiments, the work assignment engine 120 may be configured to achieve true one-to-one matching by utilizing the bitmaps/tables 128 and any similar type of data structure.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the work assignment mechanism 116 may also comprise a state monitor 124. The state monitor 124 may be configured to monitor and assess the state of the contact center on a continual or periodic basis and provide results of its assessment to the work assignment engine 120. Specifically, the state monitor 124 may provide its analysis information to the work assignment engine 120 to assist the work assignment engine 120 in making work item routing decisions. In some embodiments, the output of the state monitor 124 may be used as inputs to the normalization module 136 contained in the work assignment engine 120. The normalization module 136 may contain one or more objectives 140 identified for a contact center. The normalization module 136 may compare multiple objectives and the related ratios that are defined for the contact center to assist with the determination of the best possible work assignment.

More specifically, the work assignment engine 120 may comprise one or more skill-based objectives 140. The variable or considerations of these objectives 140 may include data received from the state monitor 124.

Specifically, the state monitor 124 may be responsible for monitoring multiple metrics that ultimately impact one or more objectives 140. Information monitored by the state monitor 124 may include information which describes an agent's current or historical (e.g., past hour, day, week, month, quarter, year, recent work assignment history, etc.) performance within the contact center. In some embodiments, the state monitor 124 may provide KPI information that is obtained from the work assignment engine 120 or from some other analysis and reporting module running within the contact center. Examples of metrics that may be monitored by the state monitor 124 include, but are not limited to, wait times associated with a contact, contact center agent skills, contact center agent efficiency, contact center state, other Key Performance Indicators (KPIs), and the like. In some embodiments, the state monitor 124 may be further configured to evaluate various contact center metrics (e.g., a measure of the contact center's actual performance) and then compare those metrics with one or more of the objectives 140 to determine if the contact center is satisfying one, some, all, or none of its objectives. The results of these comparisons may be provided to the work assignment engine 120 to assist in making work item routing decisions.

As used herein, KPIs may include, without limitation, any metric or combination of metrics that define performance of an entity within a contact center (e.g., a contact center agent, a group of contact center agents, etc.). Specifically, a KPI can be defined in terms of making progress toward strategic goals or simply the repeated achievement of some level of an operational goal.

In a contact center context, KPIs may vary depending upon whether work items correspond to outbound contacts (e.g., contacts originated by the contact center) or inbound contacts (e.g., contacts received at the contact center that have been originated outside the contact center). Non-limiting examples of outbound contact KPIs include: Contacts per hour—Average number of customers a call center agent was able to contact within an hour; Leads Conversion Rate—The percentage of leads that actually converted to sales; Hourly Sales—The average amount of sales the call center representative was able to close in an hour; Daily Sales—The average value of sales the agent was able to close in a day; and Accuracy—Extent to which a contact has been handled according to a predetermined script.

Other types of KPIs that are not necessarily specific to inbound or outbound contacts include, without limitation, customer satisfaction level, customer service level, average speed of answer, contact forecast precision level, quality of services rendered, average handling cost of a contact, agent occupancy ratio, schedule adherence and conformity, and time distribution (in service, non-service detailed time or “shrinkage”). Other examples include number of times calls are put on hold, number of transfers, $/min, $/call, number of upsells, number of cross-sells, etc. KPIs may be used to establish parameters for strategic and operational goals. The goals can be incorporated into the objectives 140 of the communication system 100.

As can be appreciated, certain components of the work assignment engine 120 (e.g., objectives 140) do not necessarily need to be executed within the work assignment engine 120 and may be executed in different parts of the communication system 100. Likewise, the state monitor 124 and/or bitmaps/tables 128 may be internal to the work assignment mechanism 116 or they may be separate from the work assignment mechanism 116.

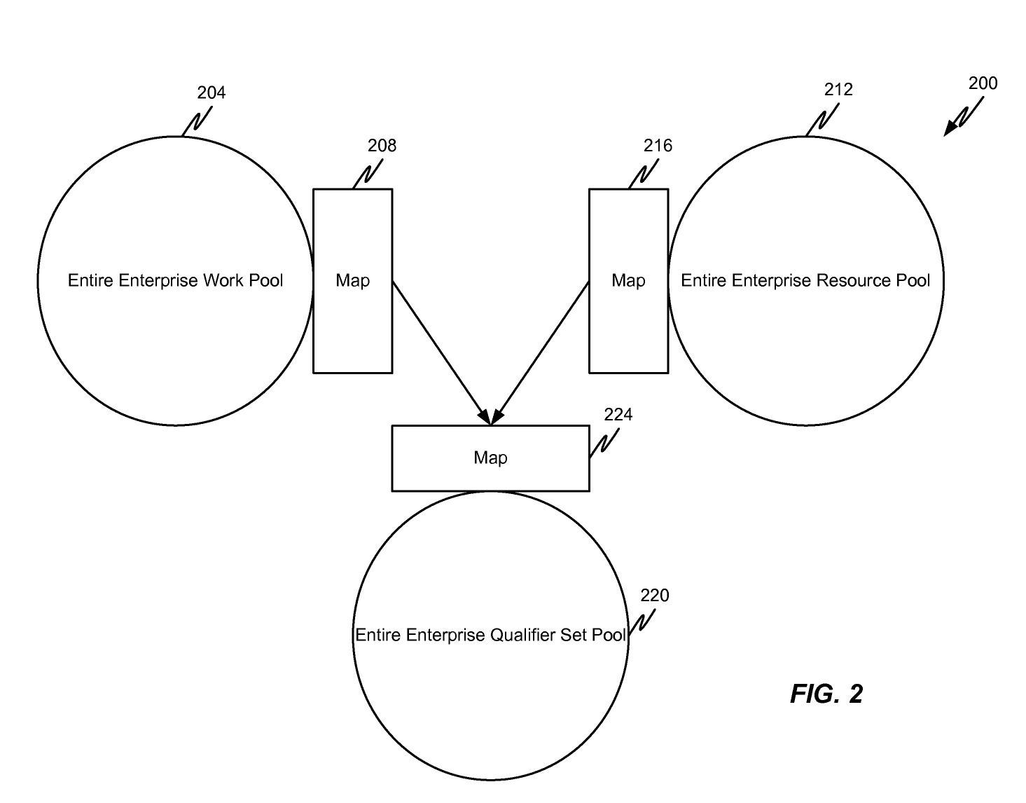

FIG. 2 depicts exemplary data structures 200 which may be incorporated in or used to generate the bitmaps/tables 128 used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the communication system 100 at any given time.

In some embodiments, the population of the work pool 204 may be limited to work items waiting for service by or assignment to a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed back to a value representing the fact that the work item is not assigned to a resource 112, thereby making that resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged in. The ineligibility of a resource 112 may be reflected in one or more bit values. As discussed in further detail herein, the eligibility of a resource 112 may differ from the appropriateness of that resource 112 to handle work as determined by the objectives 140. Specifically, depending upon an agent's assigned tier according to one or more objectives 140, an agent may actually be available to handle work items, but may be ineligible to handle work items if the agent is not meeting certain objectives (e.g., an agent might be considered ineligible if the number of times he puts calls on hold is 25% over target).

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help each the work assignment engine make an optimal work item/resource assignment decision based on the current state of each pool. Accordingly, the values in the bitmaps 208, 216, 224 may be recalculated each time the state of a pool changes (e.g., when a surplus is detected, when certain objectives are redefined or reprioritized, etc.).

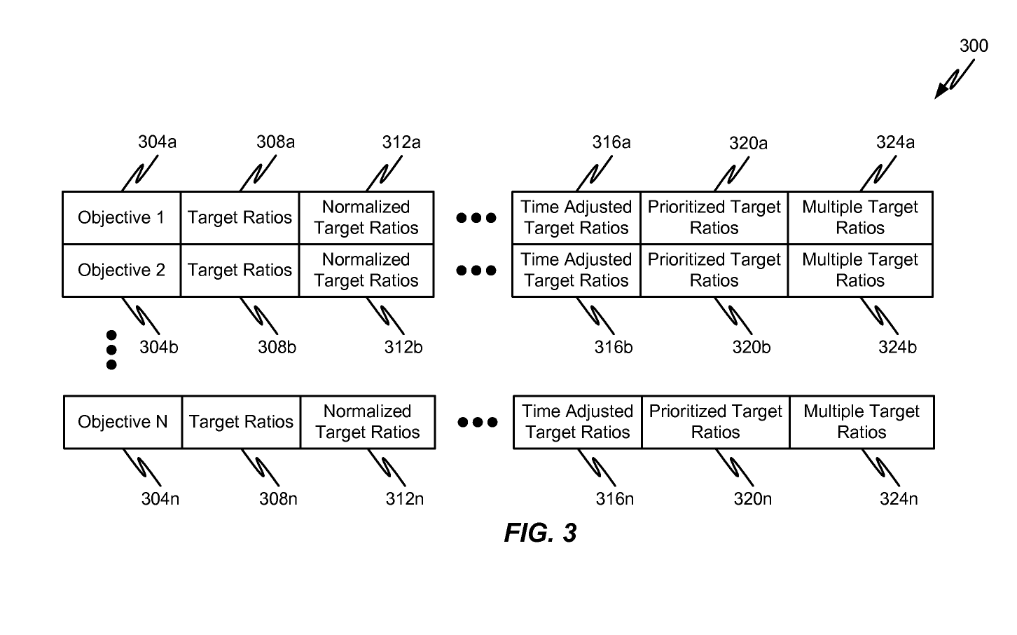

With reference now to FIG. 3, a data structure 300 will be described in accordance with embodiments of the present disclosure. The data structure 300 may comprise a number of data fields that enable a routing engine 132 to consider multiple objectives 140 in making routing decisions based on the current state of the communication system 100. In some embodiments, the fields in the data structure 300 include a plurality of objective fields 304a-n, a plurality of target ratio fields 308a-n, a plurality of normalized target ratio fields 312a-n, a plurality of time adjusted target ratio fields 316a-n, a plurality of prioritized target ratio fields 320a-n, and a plurality of multiple target ratio fields 324a-n.

As can be appreciated, the objective fields 304a-n along with the ratio fields 308, 312, 316, 320, and 324 may be integrated into or manipulated by the normalization module 136, as appropriate. The data structure 300 may also be separated or duplicated among each different objective 140, as appropriate. The data may be more or fewer data entries 304, 308, 312, 316, 320, or 324 than those shown FIG. 3, as represented by ellipses.

Target ratios 308a-n may be set for each agent skill, for an individual agent, for the entire contact center, or some other logical sub-component of the contact center. When corresponding to skills, the target ratios 308a-n may comprise values related to “Actual/Target,” “Wait Time/Wait Time Objective,” “Service Objective,” etc. Normalized target ratios 312a-n may encompass metrics where the goal is a low number (e.g., Wait Time, Predicted Wait Time, Estimated Wait Time, Average Speed of Answer, % Abandon) and metrics where the goal is a high number (e.g., % Service Level, profit/call, etc). To compare the status of objectives of different types, the target ratios may be normalized. For the low target ratios, absolute value of “Actual-Target” may be calculated, and for the high target ratios, absolute value of “Target-Actual” may be calculated, with thresholds set to measure if the Actual values are too far above or below Target. A target ratio for a skill with an ASA objective may be compared with a skill with a % SL objective. This ability to normalize the target ratios allows for a best possible work assignment.

Time adjusted target ratios 316a-n may be used when different objectives have different time windows. For example, Daily % SL and Monthly % SL. If one skill fails to meet a daily objective and a second skill fails to meet a monthly objective, it may be more important for the agent to focus on the skill with the more important objective even if the target ratio is more problematic for the less important objective. Because of this, target ratios may be adjusted to account for the time remaining using the formula “target ratio/logN time-remaining” where N=2-10.

Prioritized target ratios 320a-n may have requirements assigned or may be used as preferences when target ratios are essentially equivalent. Among a plurality of target ratios, a subset may be identified as more important than others. Certain types of businesses may consider certain objectives critical, and the target ratios are set to reflect this. For example, a company handling calls for medical issues may have a lower tolerance for Percent Abandon (% Abandon) than a company selling books. Conversely, the company selling books may prioritize Daily Sales over % Abandon, depending on its overall objectives. If a company does not have target ratios that are considered critical to the success of the business, an administrator might choose a few prioritized target ratios 320a-n to maximize resources within the contact center.

Multiple target ratios 324a-n may encompass multiple objectives. One skill may have multiple objectives. For example, skill 1 may be assigned to a customer service agent. The customer service agent may be measured by objectives like time to answer, number of calls in queue, time with customer, and after call work time. The agent may be succeeding on time to answer and number of calls in queue, but failing on time with customer and after call work time. The agent also might not be meeting the quota for upselling but may be meeting the sales/profit target. How many objectives are failing for an assigned skill and how the objectives are related may be determining factors for work assignment.

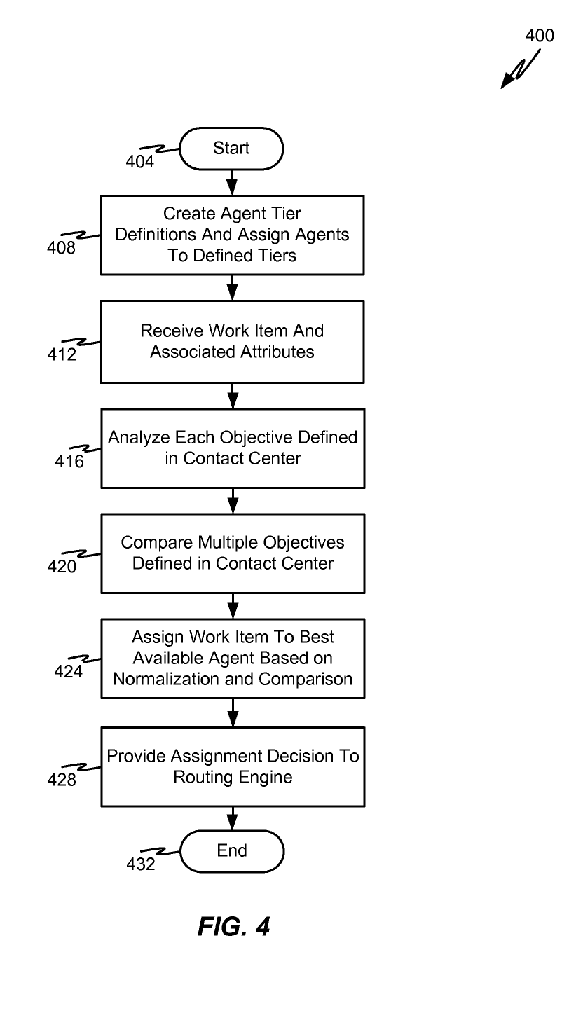

A method 400 of the application of multiple objectives 140 is shown in FIG. 4. The method depicted and described herein will refer to a simultaneous analysis and comparison of communication system objectives 140 in order to make a single work assignment decision. It should also be appreciated that multiple work assignment decisions can be made, each of which take into consideration one or multiple objectives 140. Generally, the method 400 begins with a start operation 404 and ends with an end operation 432. While a general order for the steps of the method 400 are shown in FIG. 4, the method 400 can include more or fewer steps or the order of the steps can be arranged differently than those shown in FIG. 4. The method 400 can be executed as a set of computer-executable instructions executed by a computer system and encoded or stored on a non-transitory computer readable medium. The term “computer-readable medium” as used herein refers to any tangible storage that participates in providing instructions to a processor for execution. Such a medium may take many forms, including but not limited to, non-volatile media, volatile media, and transmission media including, for example, NVRAM, magnetic or optical disks, dynamic memory, such as main memory, computer-readable memory like a floppy disk, a flexible disk, hard disk, magnetic tape, or other magnetic medium, magneto-optical medium, a CD-ROM, any other optical medium, a RAM, a PROM, and EPROM, a FLASH-EPROM, a solid state medium like a memory card, any other memory chip or cartridge. When the computer-readable media is configured as a database, it is to be understood that the database may be any type of database, such as relational, hierarchical, object-oriented, and/or the like. Hereinafter, the method 400 shall be explained with reference to the systems, components, modules, software, data structures, etc. described in conjunction with FIGS. 1-3.

In typical circumstances, a contact center agent might be assigned a definition and a tier value, in step 408. The method continues when a work item and attributes of the work item (e.g., skill or processing requirements) are received at the communication system 100, in step 412. This particular step may occur when the work item is received at the work assignment engine 120. The attributes of the work item may be obtained using any known mechanisms such as obtaining information from a customer database, analyzing caller identification information, receiving information from a customer via an IVR, etc. These attributes may be used to create the bitmaps described in FIG. 2.

After the work item has been received and attributes of the work item have been determined, in step 412, the analysis of each objective 140 may begin, in step 416. The objectives 140 may be identified and ratios may be set for one or more objectives 140. Once all of the objectives 140 have been analyzed in step 416, the set of multiple objectives 140 may be subject to comparison for appropriate work assignment by the normalization module 136, in step 420. Once the normalization and comparison are complete, the work may be assigned to the best available agent, in step 424, by the work assignment engine 120.

The work assignment engine 120 may provide the assignment information to the routing engine 132 to effect the work assignment decision, in step 428. In particular, the routing engine 132 may establish a communication channel or communication session between the communication device 108 associated with the work item and the customer communication device of the selected resource 112. The manner in which the communication channel or session is established may vary depending upon the nature of the work item/contact (e.g., whether the contact is a real-time or non-real-time contact).

The work assignment decision made in step 424 after multiple simultaneous contact center objectives have been applied may be slightly different than if the objectives were done sequentially and then enforced. Specifically, if during an analysis an agent becomes available that is meeting more of the objectives than another agent, the work item can be assigned to the better agent immediately. There is no wait time to run through the rest of the objectives sequentially or the assignment going to a good agent, but not necessarily the best agent, based on all of the criteria. If there are no changes of objectives during the analysis period, then the work item can be assigned to the best suited available and eligible agent as dictated either by idle agent time (e.g., assign the work item to the agent that has been waiting the longest) or by analyzing the bitmaps 208, 216, 224. It should be appreciated that the selection of a “best” agent will depend upon whether the communication system 100 is queue-based or queueless.

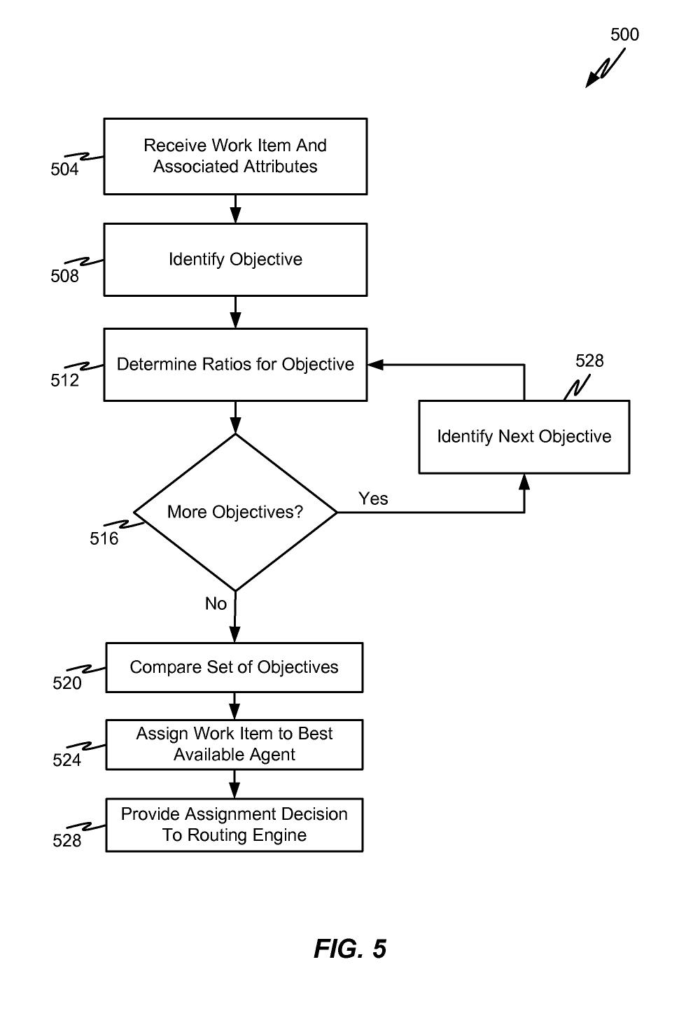

A method 500 for managing objectives is shown in FIG. 5. Once the objectives 140 have been identified and the work assignments have been made, the assignment decisions can be sent to the routing engine 132 as shown in FIG. 5. Generally, the method 500 begins with the receipt of work items and associated attributes, in step 504, and ends with providing the assignment decision to the routing engine, in step 524. While a general order for the steps of the method 500 are shown in FIG. 5, the method 500 can include more or fewer steps or the order of the steps can be arranged differently than those shown in FIG. 5. The method 500 can be executed as a set of computer-executable instructions executed by a computer system and encoded or stored on a non-transitory computer readable medium. Hereinafter, the method 500 shall be explained with reference to the systems, components, modules, software, data structures, etc. described in conjunction with FIGS. 1-4.

The work assignment mechanism 116 may receive work items and associated attributes 504. Work items may come from a customer communication device 108 through a communication network 104 to a work assignment mechanism 116. The attributes of a communication system 100 may be preset in software or may be assigned by an administrator. The work assignment engine 120 may receive work items and associated attributes, in step 504. The work assignment engine 120 may identify an objective, in step 508. The work assignment engine 120 may determine the ratios for First Objective 304a, identified in step 512. These ratios may include target ratios 308, normalized target ratios 312, time adjusted target ratios 316, prioritized target ratios 320, multiple target ratios 324, or any other ratios. Once the ratios for First Objective 304a have been identified, the work assignment engine 120 may check to see if there are more objectives 140, in step 516. If there are additional objectives 140 that should be managed, the next sequential objective may be identified, in step 528. Once Second Objective 304b has been identified, ratios may be determined for Second Objective 304b. These ratios may include target ratios 308a, normalized target ratios 312a, time adjusted target ratios 316a, prioritized target ratios 320a, multiple target ratios 324a, or any other ratios. Steps 512, 516, and 528 may be executed until the Objectives 304a-n have been satisfied. Once the Objectives 304a-n have been satisfied and the answer to the question of more objectives in step 516 is no, comparison of the identified set of objectives may be done, in step 520, by the normalization module 136. After the comparison in step 520, the work assignment engine 120 may determine the work assignment to the best available resource 112 for resolution. The work assignment engine 120 may provide the work item assignment decision to the routing engine 132. The routing engine 132 may send the work item to the assigned resource 112. The analysis of each objective defined in the contact center, in step 420, is done along with the comparison of multiple objectives, in step 416, so that the work assignment engine's assignments are consistent with all of the objectives 140 for the contact center. The process may also be implemented when an agent with multiple skills becomes available and the work assignment engine wishes to assign the next item of work based on the simultaneous analysis of the plurality of objectives.

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

In additional embodiments, creating and attempting to satisfy multiple contact center objectives simultaneously could be used at levels above the level of an individual agent. These levels might include, but are not limited to, a contact center level, a location/city level, a work assignment/type level, or any other stratification or prioritization at one or more levels.

In additional embodiments, a scoring method or super-metric could be implemented. Depending on the state of one or more objectives, a grade or color could be assigned to quantify or visually represent status of the objectives. If the goals are in significant opposition, the grade or color might assist in determining what action may be taken and whether or not multiple thresholds or levels might be required.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The foregoing discussion of the disclosure has been presented for purposes of illustration and description. Further, the description is not intended to limit the disclosure to the form disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosure and to enable others skilled in the art to utilize the disclosure in such or in other embodiments and with various modifications required by the particular application or use of the disclosure. It is intended that the appended claims be construed to include alternative embodiments to the extent permitted by the prior art.

1. A method, comprising:
receiving a work item at a work assignment engine, the work assignment engine comprising processor-executable instructions stored in a non-transitory computer readable medium of a contact center;
simultaneously analyzing, by a processor executing the work assignment engine, a plurality of objectives, wherein simultaneously analyzing the plurality of objectives comprises:
normalizing a first objective in the plurality of objectives with a second objective in the plurality of objectives, wherein normalizing the first objective with the second objective comprises determining the-time-adjusted target ratios for both the first and second objectives;
determining, based on the simultaneous analysis by the processor of the plurality of objectives, an optimal resource to receive the work item; and
causing the work item to be routed to the optimal resource.

2. The method of claim 1, wherein the optimal resource satisfies the first objective in the plurality of objectives better than any other resource in the contact center.

3. The method of claim 2, wherein a second resource satisfies the second objective in the plurality of objectives better than the optimal resource.

4. The method of claim 3, wherein the first objective is assigned a greater weight of importance as compared to the second objective.

5. The method of claim 2, wherein the optimal resource satisfies the second objective in the plurality of objectives better than any other resource in the contact center.

6. (canceled)

7. The method of claim 1, wherein the first objective is a long-term objective, wherein the second objective is a short-term objective, and wherein the target ratios of the first and second objectives have varying time windows requiring time-adjusted target ratios.

8. The method of claim 7, wherein the time-adjusted target ratio of both the first and second objectives comprise a target ratio divided by logN of time remaining, wherein N is between or equal to 2 and 10.

9. The method of claim 8, wherein each objective in the plurality of objectives comprises at least one key performance measure, wherein key performance measures comprise metrics for wait time, efficiency of contact center agent and contact center state, and wherein observation of rate of change of one or more metrics influence objective priority.

10. A contact center, comprising:
a work assignment engine configured to receive a work item, the work assignment engine comprising processor-executable instructions stored in a non-transitory computer readable medium of a contact center, wherein the work assignment engine, is then executed by a processor of the contact center, simultaneously analyzes a plurality of contact center objectives, by normalizing a first objective in the plurality of objectives with a second objective in the plurality of objectives, wherein normalizing the first object with the second object comprises determining time-adjusted target ratios for both the first and second objectives,
then determines, based on the simultaneous analysis, an optimal resource to receive the work item, and
causes the work item to be routed to the optimal resource.

11. The contact center of claim 10, wherein the optimal resource satisfies the first objective in the plurality of objectives better than any other resource in the contact center.

12. The contact center of claim 11, wherein a second resource satisfies the second objective in the plurality of objectives better than the optimal resource.

13. The contact center of claim 12, wherein the first objective is assigned a greater weight of importance as compared to the second objective.

14. The contact center of claim 13, wherein the optimal resource satisfies the second objective in the plurality of objectives better than any other resource in the contact center.

15. (canceled)

16. The contact center of claim 10, wherein the first objective is a long-term objective, wherein the second objective is a short-term objective and wherein the target ratios of the first and second objectives have varying time windows requiring time-adjusted target ratios.

17. The contact center of claim 16, wherein the time-adjusted target ratio of both the first and second objectives comprise a target ratio divided by logN of time remaining, wherein N is between or equal to 2 and 10.

18. The contact center of claim 17, wherein each objective in the plurality of objectives comprises at least one key performance measure, wherein key performance measures comprise metrics for wait time, efficiency of contact center agent and contact center state and wherein observation of rate of change of one or more metrics influence objective priority.

19. A method, comprising:
determining, by a work assignment engine, comprising processor-executable instructions stored in a non-transitory computer readable medium of a contact center, that a resource has become available;
simultaneously analyzing, by a processor executing the work assignment engine, a plurality of objectives by normalizing a first objective in the plurality of objectives with a second objective in the plurality of objectives, wherein normalizing the first objective with the second objective comprises determining the time-adjusted target ratios for both the first and second objectives,
determining, based on the simultaneous analysis by the processor of the plurality of objectives, an optimal work item to be assigned to the resource; and
assigning, by the processor executing the work assignment engine, the optimal work item to the resource.

20. The method of claim 19, wherein the optimal work item satisfies the first objective in the plurality of objectives better than any other work item in the contact center, wherein a second work item satisfies the second objective in the plurality of objectives better than the optimal resource, and wherein the first objective is assigned a greater weight of importance as compared to the second objective.

21. A method of claim 9, wherein the first and second objective in the plurality of objectives is simultaneously satisfied, and wherein the analyses of the objectives are performed in parallel.

22. The contact center of claim 18, wherein the first and second objective in the plurality of objectives is simultaneously satisfied, and wherein the analyses of the objectives are performed in parallel.
